(19) United States
(12) Patent Application Publication
(10) Pub. No.: US 2004/0208190 A1
(43) Pub. Date: Oct. 21, 2004

(54) System for communication between field equipment and operating equipment

(75) Inventor: Dirk Wagener, Stadthagen (DE)

Correspondence Address: Michael M. Rickin, Esq., ABB Inc., Legal Department-4U6, 29801 Euclid Avenue, Wickliffe, OH, 44092-1898, US

(73) Assignee: ABB Patent GmbH

(21) Appl. No.: 10/822,304

(22) Filed: Apr. 12, 2004

(30) Foreign Application Priority Data
Apr. 16, 2003 (DE) 103 17 497.4

(51) Int. Cl. H04L 12/56

(52) U.S. Cl. 370/401; 370/466

(57) ABSTRACT

A system for communication between operating equipment and field equipment, which, via a communications network, can be connected at least temporarily to a terminal for the purpose of data interchange. To this end, there is provided an application computer and a gateway server at nodes of the communications network. Loaded and executed on the gateway server are programs which comprise methods for speech recognition, for converting text to speech and telephony functions and also interpretation of VXML documents. The data interchange between the terminal and the gateway server is carried out using natural speech. A server process and at least one field-equipment specific software program is loaded and executed on the application computer and comprises the control mechanism for a specific item of field equipment which can be addressed by the application computer.

### 1. FIELD OF THE INVENTION

The invention relates to a system for communication between operating equipment and field equipment in the industrial environment of process and power installations.

### 2. DESCRIPTION OF THE PRIOR ART

Field equipment of this type is a constituent part of a control loop and has a communicative connection with a central open-loop and closed-loop control device. The field equipment can be operated on-site and remotely for the purposes of configuration, parameterization and/or diagnosis.

For the purpose of on-site operation, it is normal to connect a portable operating device to the field equipment. In the case of wire-bound communication between the field equipment and the central open-loop and closed-loop control device, the portable operating device is connected to the connecting line between the field equipment and the central open-loop and closed-loop control device. In the case of wire-free communication between the field equipment and the central open-loop and closed-loop control device, the field equipment and the portable operating device are each equipped with an infrared communications interface. However, the communication on the basis of infrared radiation assumes a “visual connection” between the communication partners and can therefore be used only to a restricted extent. Furthermore, the range of the infrared connection is very limited.

The known remote operation of the field equipment is carried out via suitable components within the scope of the central open-loop and closed-loop control device. The central open-loop and closed-loop control device is regularly computer-based, so that for the remote operation of the field equipment, specific software programs with user interfaces are provided. In this case, the distance from the field equipment is limited by the system architecture within the process installation.

Both the on-site operation and the known remote operation of the field equipment are afflicted by the disadvantage that the level of equipment provided for this purpose with regard to the function and the user interface has to be designed specifically for the purpose of the field equipment operation.

Furthermore, DE 201 03 982 discloses a communications arrangement for field equipment for data interchange with a portable operating device, in which the field equipment and the portable operating device are each equipped with a level of telecommunications equipment of a mobile telephone, have an unambiguously identified subscriber code and are subscribers in a locally limited telecommunications network. The operation of the field equipment is carried out via the keyboard of the mobile telephone. The multiple allocation of the few keys and their small surface, and also the small spacing of the keys from one another, make the operation more difficult in the rough operating conditions that exist in the industrial environment.

The invention is therefore based on the object of specifying a system for communication between operating equipment and field equipment which permits the operation of the field equipment ergonomically even under rough conditions.

The invention is based on field equipment which, via a communications network, can be connected at least temporarily to a terminal for the purpose of data interchange.

According to the invention, the communications network comprises an application computer and a gateway server in addition to the components for data transmission at nodes. The field equipment is connected to the application computer via components for data transmission belonging to the telecommunications network. At least one further software program, in addition to the server process, is loaded and executed on the application computer.

This software program is field-equipment specific and comprises the control mechanism for the field equipment. This is understood to mean all the conditions which are necessary for the operation of the field equipment. This also comprises the possible functionalities of the field equipment and the plausibility functions, such as checking limiting values, since the field equipment supports certain parameters only within a specific span. To some extent, functionalities of the field equipment may be executed only when specific boundary conditions exist. The plausibility functions are generally field-equipment specific for each item of field equipment that can be addressed by the application computer.

The terminal is suitable for speech input and output and connected to the gateway server via components for data transmission belonging to the communications network.

The gateway server is a computer on which at least a first and a second software program are loaded and executed. The first software program is a speech/telephony platform. The speech/telephony platform comprises methods for speech-recognition, for the conversion of text to speech and telephony functions. The second software program is a speech browser which has methods for the interpretation of VXML documents (Voice EXtensible Markup Language). The gateway server is a device for converting speech information into machine-readable form and vice versa.

The gateway server is operatively connected to the application computer, which responds to a request from a gateway server.

In order to operate the field equipment, a request is sent by the terminal to the gateway server via the communications network by means of speech. The request is received by the gateway server and converted into machine-readable form. The request is then transferred to the application server. The request is then executed. For this purpose, the field-equipment specific software program belonging to the field equipment is started. Depending on the type of request, data from the field equipment to be sent back to the terminal is determined.

The data returned from the field-equipment specific software program is transferred to the gateway server in a form that can be understood by the gateway server. The latter in turn generates speech from this data, which is then provided to the requesting terminal.

The field-equipment specific software program is advantageously independent of the type of terminal provided for the operation of the field equipment. The operation of field equipment with various types of mobile terminals by means of natural speech is achieved with comparatively low complexity of each individual field-equipment specific software program.

The operation of field equipment by means of natural speech is advantageously also ergonomically possible under rough conditions.

For the purpose of integration of a further item of field equipment, a further field-equipment specific software program is loaded onto the application computer and caused to execute.

Therefore, with high variability, a simple structure is achieved, which means that the development and testing effort is reduced and the availability is increased.

### SUMMARY OF THE INVENTION

### DESCRIPTION OF THE DRAWING

The only drawing FIGURE shows a basic illustration of the logical and physical structure of the system of the present invention.

### DESCRIPTION OF THE PREFERRED EMBODIMENT(S)

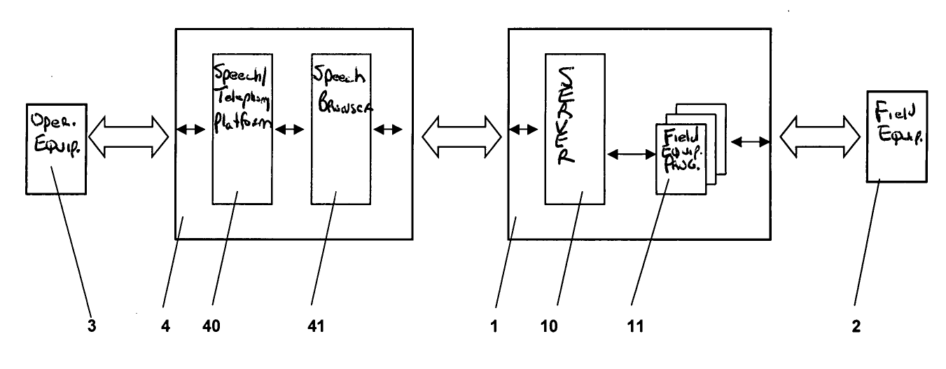

Referring now to FIG. 1, there is shown a basic illustration of the logical and physical structure of the system of the present invention for communication between operating equipment 3 and field equipment 2 by means of speech is shown in the single figure. In this case, the field equipment 2 is connected to an application computer 1. The operating equipment 3 can be connected to the gateway server 4, at least temporarily, via a communications network. The gateway server 4 is connected to the application computer, at least temporarily, via a network.

On the application computer 1, on which a server process 10 is executed in accordance with the invention, at least one field-equipment specific software program 11 is loaded. The application computer 1 is designed such that the server process 10 is suitable for receiving requests in machine-readable form from the gateway server.

The field equipment 2 can be designed as a sensor or actuator. These include, in particular but not finally, transducers for converting a physical variable into an electrical variable and actuating equipment for converting an electrical variable into a mechanical variable. A plurality of items of field equipment 2 can be connected to an application computer 1.

The field-equipment specific software program 11 comprises the control mechanism for the field equipment 2. This is understood to mean all those conditions which are necessary for the operation of the field equipment 2. This also comprises the possible functionalities of the field equipment 2 and the plausibility functions, such as checking limiting values, since the field equipment 2 supports certain parameters only within a specific span. To some extent, functionalities of the field equipment 2 may be executed only when specific boundary conditions exist. The plausibility functions are generally field-equipment specific for each item of field equipment 2 that can be addressed by the application computer 1. In each case a specific software program 11 is provided for each type of field equipment 2.

The operating equipment 3 is a communications terminal having means for speech input and output for operating the field equipment 2. These include, in particular but not finally, mobile telephones and fixed network telephones.

In one embodiment of the invention, a mobile telephone is provided as a terminal 3, which is connected to the gateway server 4 via a telecommunications network. The gateway server has a speech/telephony platform 40, which performs speech recognition, text-to-speech and telephony functions. Furthermore, the gateway server has a speech browser 41 which is provided for the interpretation of VXML (Voice EXtensible Markup Language) documents.

In order to operate the field equipment 2, a request is sent by the terminal 3 to the gateway server 4 via the communications network by means of speech. For this purpose, initiated by the operator, a connection is made between the terminal 3 and the gateway server 4. The operator is presented with a speech menu, from which one of the options offered is selected by speech input. The verbal answer is analysed by the speech/telephony platform 40. In the process, the latter uses the speech recognition functionality to convert the answer into a machine-readable input. In particular, series of interactive dialogues can be provided in order to determine the user requirement.

The request is received by the gateway server 4 and converted into machine-readable form. The request is then transferred to the application server 1. Depending on the user request, a collection of input parameters is packed to form a query and transferred to the application computer 1.

The query is received by the application computer 1 and interpreted. The item of field equipment 2 addressed and the user request are identified. The request is then executed. For this purpose, the field-equipment specific software program 11 belonging to the item of field equipment 2 is started. Depending on the type of request, data from the field equipment 2 to be sent back to the terminal 3 is determined.

From the return values from the field-equipment specific software program 11, a VXML document is created and this is passed back to the gateway server 4. The latter produces speech again from this. In the process, the gateway server 4 interprets the VXML document with the aid of the speech browser 41 and, with the aid of the text-to-speech functionality contained in the speech/telephony platform 40, converts the data into speech information.

The speech information is then sent via the telecommunications network to the requesting mobile telephone 3 and reproduced acoustically by the mobile telephone 3.

In a particular refinement of the invention, the application computer 1 and the gateway server 4 are the same physical machine, on which various services and programs 10, 11, 40 and 41 are executed.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A system for communication between operating equipment and field equipment, comprising:
a communications network for connecting said operating equipment and said field equipment at least temporarily to a mobile terminal for the purpose of data interchange;
said communications network comprising an application computer and a gateway server and in addition components for data transmission at nodes;
said field equipment connected to said application computer by way of said components for data transmission belonging to said communication network;
a server process and at least one field-equipment specific software program loaded and executed on said application computer;
said terminal suitable for speech input and output and is connected to the gateway server by way of components for data transmission belonging to said telecommunications network,
a first and a second software program are loaded and executed on said gateway server;
said first software program is a speech/telephony platform which comprises methods for speech recognition, for converting text to speech and telephony functions;
said second software program is a speech browser. which has methods for the interpretation of VXML documents, and
natural speech is provided for the data interchange between said terminal and said gateway server.
